(19) United States
(12) Patent Application Publication
(10) Pub. No.: US 2010/0095220 A1
(43) Pub. Date: Apr. 15, 2010

(54) METHODS AND SYSTEMS FOR PROVIDING A MINI-WEBPAGE WITHIN A WEBPAGE

(75) Inventor: Hisham Kassab, Rockville, MD (US)

Correspondence Address: DICKINSON WRIGHT PLLC, 1875 Eye Street, NW, Suite 1200, WASHINGTON, DC, 20006, US

(73) Assignee: MOBILAPS LLC, SILVER SPRINGS, MD (US)

(21) Appl. No.: 12/443,154

(22) PCT Filed: Sep. 28, 2007
(86) PCT No.: PCT/US07/79851

§ 371 Date: Mar. 26, 2009

Related U.S. Application Data
(60) Provisional application No. 60/848,193, filed on Sep. 28, 2006.

(51) Int. Cl. G06F 3/01

(52) U.S. Cl. 715/745; 715/760

(57) ABSTRACT

Methods and systems to enable an Intermediate Network Entity (INE) to modify a Web Page requested by an end-user. The modification may involve placing a Mini-Webpage designated areas of the requested Web Page. An INE may be enabled to receive a request for a Web Page, process the request, modify the requested Web Page by placing Mini-Webpages in designated areas of the Web Page. The methods would allow the Mini-Webpages to be formed by the INE, Web Page provider or a third party ad server. The Mini-Webpages may be targeted based on certain criteria such as the nature of the Web Page requested, the information about the end-user, and the information about the INE. An INE may share some of the economic benefits associated with the ability to convey desired information to an end-user.

### CROSS-REFERENCE TO RELATED APPLICATIONS

This patent application claims the benefit of the filing date of U.S. Provisional Patent Application Ser. No. 60-848193, filed Sep. 28, 2006 and entitled “METHOD FOR PROVIDING A MINI-WEBPAGE WITHIN A WEB PAGE,” the entire contents of which are hereby expressly incorporated by reference.

### FIELD OF THE INVENTION

The present invention relates to the field of computer software, and more specifically, to methods and systems that would facilitate rendering of one or more Mini-Webpages within a requested Web Page by an Intermediate Network Entity such as an Internet Service Provider.

### BACKGROUND OF THE INVENTION

Internet Service Providers (ISP's) or related entities (hereinafter any entity on the path between a client and a server will be referred to as an “intermediate network entity” (INE)) in general have increasingly been relegated to commoditized bit-pipes that carry Internet traffic from the end-user to different portals and websites on the World Wide Web. Despite the dotcom bust, surviving companies such as YAHOO, AMAZON, EBAY, and GOOGLE (registered service marks) are thriving. However, ISP's have been largely kept out of this business.

Conventional public Wi-Fi hotspot controllers have experimented with Point-of-Sale (POS) advertising on a user's screen using several technologies/means including (1) unsolicited pop-up windows; and (2) URL redirection, whereby the end-user, upon starting up the web browser, is redirected to a login page that typically contains advertising for the location owner. The first method may be annoying to users. The second method is minimally intrusive to users, but the advertising appears only once, unless the user is redirected to the login page at regular intervals, which may be offensive.

Thus, it would be advantageous to provide a system and method for an ISP or an INE to insert Mini-Webpages (a mini-Webpage is a miniature version of a typical full Web Page and may emulate the full-functionality of a full web-page or it may be different from the full Web Page) into Web Pages requested by an end-user before they are provided to a web browser of the end-user. Such system would permit ISP's or other entities to provide e-commerce, e-services, advertising or other services that are integrated with the presentation of content provided to the user. Thus, there is a need in the art for methods and systems that can assist an ISP or an INE to achieve above advantages.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention generally relates to methods and systems that enable ISP's or INE's to modify a Web Page requested by an end-user. The modification may involve placement of a Mini-Webpage in a designated area of the requested Web Page. The methods and systems described herein can provide one or more of the following advantages: 1) enable ISP's and/or INE's to derive financial and technical benefits, b) facilitate ISP's and/or INE's to provide e-commerce, e-services, advertising or other services that are integrated with the presentation of content provided to the end-user, and c) enable ISP's and/or INE's to have a better control over the Web Pages being received by an end-user.

In one aspect of the present invention, methods for rendering one or more Mini-Webpages within a requested Web Page by an Intermediate Network Entity (INE) are disclosed. These methods involve receiving a request for a Web Page located at a specified web address by an INE from an end-user; processing of the request for the Web Page by the INE; modifying the requested Web Page such that the requested Web Page when delivered to the web browser contains at least one Mini-Webpage in one or more designated areas of the requested Web Page; and delivering the modified Web Page along with the at least one Mini-Webpage to the web browser.

In another aspect of the present invention, systems for enabling an Intermediate Network Entity (INE) to modify a Web Page requested by an end-user by placing one or more Mini-Webpages within the requested Web Page are described. These systems include an input device that would enable an end-user to request a Web Page via a web browser; a device that can transmit the request; a processing agent of an INE that can receive and process the request; a Web Page modification agent used to alter the requested Web Page and place at least one Mini-Webpage; and a delivering agent; wherein the delivering agent returns to the web browser of the end-user modified Web Page along with the at least one Mini-Webpage.

In yet another aspect of the present invention, machine readable media having in them instructions that, when executed by the machine, cause the machine to execute a set of operations which enable an Intermediate Network Entity (INE) to modify a Web Page requested by an end-user by placing one or more Mini-Webpages within the requested Web Page. The machine readable media of this aspect of the invention include instructions which when executed can cause a machine to perform operations resulting in receiving a request for a Web Page located at a specified web address by an Intermediate Network Entity (INE) from an end-user; processing of the request for the Web Page by the INE; modifying the requested Web Page such that the requested Web Page when delivered to the web browser contains at least one Mini-Webpage in place of one or more designated areas; and delivering the modified Web Page along with the at least one Mini-Webpage to the web browser.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF DRAWINGS

FIG. 1 is a schematic diagram of a general-purpose digital computing environment.

FIG. 2 provides an illustration of various client-server architectures using web browsing architecture.

FIG. 3 illustrates how a client and server may be connected via the Internet.

FIG. 4 shows the passage of Internet traffic between one or more proxy servers before flowing through the Internet.

FIG. 5 illustrates the process that is undertaken when an INE end-user downloads a Web Page from an origin server.

FIG. 6 provides an example of a banner-ad.

FIG. 7 provides an example of codelets.

FIG. 8 illustrates the process that occurs when a web-page contains banner-ads served by a TPAS.

FIG. 9 illustrates Internet Content Adaptation Protocol (ICAP) techniques.

FIG. 10 depicts an overview of one aspect of the present invention.

FIG. 11 is a block diagram of a method for modifying a requested Web Page according to one embodiment of the present invention.

FIG. 12 is a block diagram of an alternative embodiment of the method of the present invention.

### DETAILED DESCRIPTION OF THE INVENTION

The invention is now described with reference to the drawings, wherein like reference numerals are used to refer to like elements throughout. In the following description, for purposes of explanation, numerous specific details are set forth to provide a thorough understanding of the subject invention. It may be evident, however, that the invention can be practiced without these specific details. In other instances, well-known structures and devices are shown in block diagram form to facilitate describing the invention.

For this application, the term Web Page is intended to include any web content that can be viewed within a web browser including but not limited to content created using HTML, audio and video streams, JavaScript, Java Applets, Flash, Shockwave, CGI and the like. Also, in this application, the terms Internet Service Provider (ISP) and Intermediate Network Entity (INE) are used interchangeably and they intend to include any entity on the path between a client and a server.

For purposes of this application, a Mini-Webpage is a miniature version of a typical full Web Page and may emulate the full-functionality of a full Web Page or it may be different from the full Web Page. For example, the Mini-Webpage can be different from the full Web Page in that it may likely be contained within a larger Web Page and that its dimensions may not necessarily span the dimensions of the web-browser's main window.

The present invention generally relates to methods and systems that provide an Intermediate Network Entity such as an ISP with an ability to insert or cause to insert Mini-Webpages in designated areas of a Web Page requested by an end-user. Various aspects of the present invention can advantageously provide INE's with tools to beneficially leverage internet advertisement and/or e-commerce and/or e-services revenue. The present invention can be implemented using a number of methods described below. Below are some general systems and methods that can be used to implement one or more aspects of the present invention.

General Purpose Digital Computing Environment

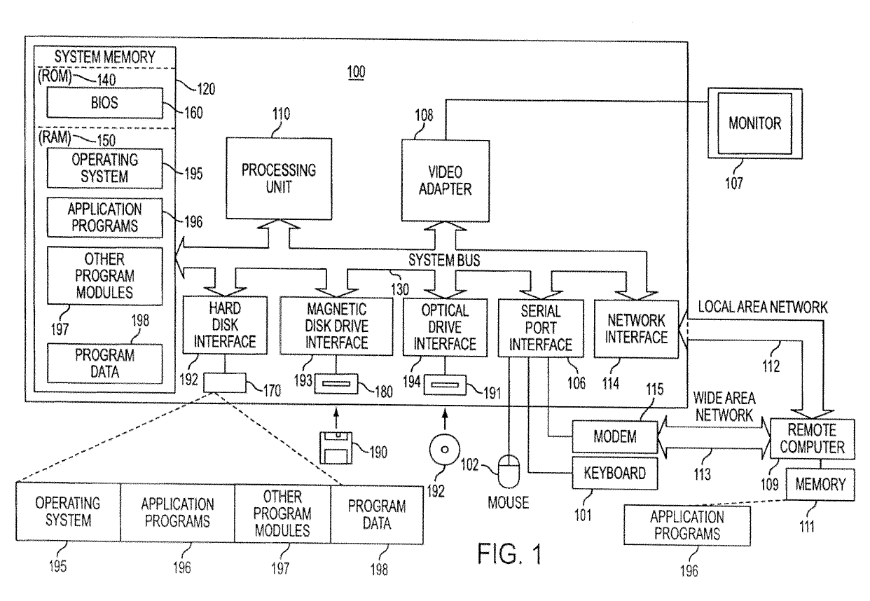

FIG. 1 is a schematic diagram of a conventional general-purpose digital computing environment that can be used to implement various aspects of the invention. Computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory includes read only memory (ROM) 140 and random access memory (RAM) 150.

A basic input/output system 160 (BIOS), containing the basic routines that help to transfer information between elements within the computer 100, such as during start-up, is stored in ROM 140. Computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary operating environment.

A number of program modules can be stored on the hard disk, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner, or the like. These and other input devices are often connected to the processing unit 110 through a serial port interface 106 that is coupled to the system bus, but may be connected by other interfaces, such as a parallel port, game port or a universal serial bus (USB). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment using logical connections to one or more remote computers, such as a remote computer 109. Remote computer 109 can be a server, a router, a network PC, a peer device or other common network node, and typically includes many or all of the elements described above relative to computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve Web Pages from a web-based server. Any of various conventional web browsers can be used to display and manipulate data on Web Pages.

Client-Server Architecture

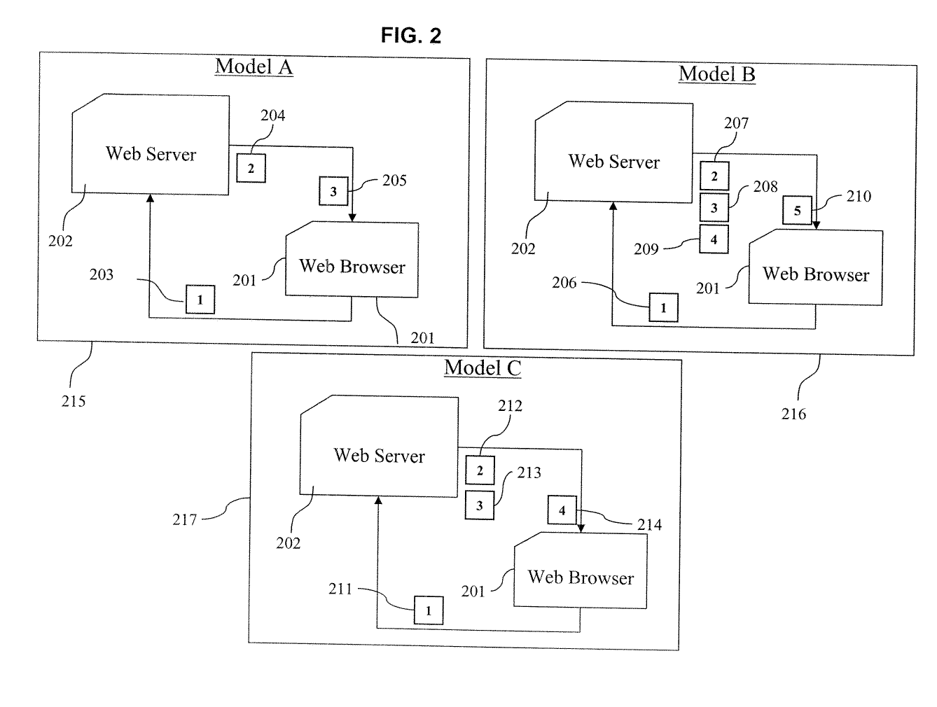

FIG. 2 provides an illustration of various client-server architectures using the widely used web browsing architecture that can be used to implement one or more aspects of the present invention. As FIG. 2 illustrates, web browsing has a client-server architecture, whereby the client 201 is typically referred to as a web browser, and the server 202 is typically referred to as a web server. In Model A 215, the interaction begins with 203, with the web browser requesting a particular html file. The web server locates the file and sends it to the web browser 204, and the web browser displays the file 205. In Model A 215, the HTML page is static, which means it will not change unless it is explicitly modified by its author/developer. In Model B 216, the web server performs some processing, based on CGI technology. After the web browser sends its request 206, the web server locates an appropriate CGI program and passes the request to that CGI program 207. The CGI program processes the request and sends the resulting output data back to the web server 208. The web server then sends that data back to the web browser 209, and the web browser displays the data 210. In Model B 216, the CGI program generates a dynamic HTML page. The contents of the page depend on the query passed to the CGI program. Model C 217 shows another case involving a dynamic response. In this model, the dynamic response is generated using server side technologies such as (1) Personal Home Pages (PHP); (2) Active Server Pages (ASP); (3) Java Server Pages; and (4) Server Side Includes (SSI).

In Model C 217, after the web browser sends its request 211, the web server checks the corresponding file and executes any embedded scripts 212, and puts together the final formatted document to be sent to the web browser 213. The web browser then displays the document 214.

Clients and servers communicate with each other using a set of instructions, referred to as protocols, over networks. Indeed, networks may be considered the backbone of client-server relationships. Clients may communicate with servers over any of various conventional networking technologies including but not limited to (1) Ethernet-based local area networking; (2) wide area networking; and (3) TCP/IP-based Internet networking.

The Internet has become widely used network for various client-server applications. Indeed, the Internet revolves around the client-server architecture. Client-server applications available over the Internet include but are not limited to (1) web browsing; (2) email; (3) gaming; (4) streaming audio; (5) streaming video; (6) file transfer; (7) special-purpose applications; and the like. Among the widely available clients used in Internet-based client-server applications are: (1) Web browsers such as Internet Explorer, Firefox, Netscape (including media players within the web browser); (2) Email clients such as Netscape Communicator, Microsoft Outlook, Microsoft Outlook Express, and Eudora; (3) Newsgroups clients; (4) instant messaging applications; (5) audio players such as RealPlayer; (6) video players such as MediaPlayer; (7) custom-made applications such as Softphones for Voice-Over-IP. The client device hosting the client software is typically a client computer; however, it may also be a dedicated device such as a television (TV), an audio player or a game player. Any or all of the above may be used in conjunction with the inventive principles.

A request for service sent from a client to a server can be referred to as a request message. An example of a request message is an HTTP request. The service provided by the server shall be referred to as a response message. One example of a response message is one that contains an HTML document that is typically provided by a web server.

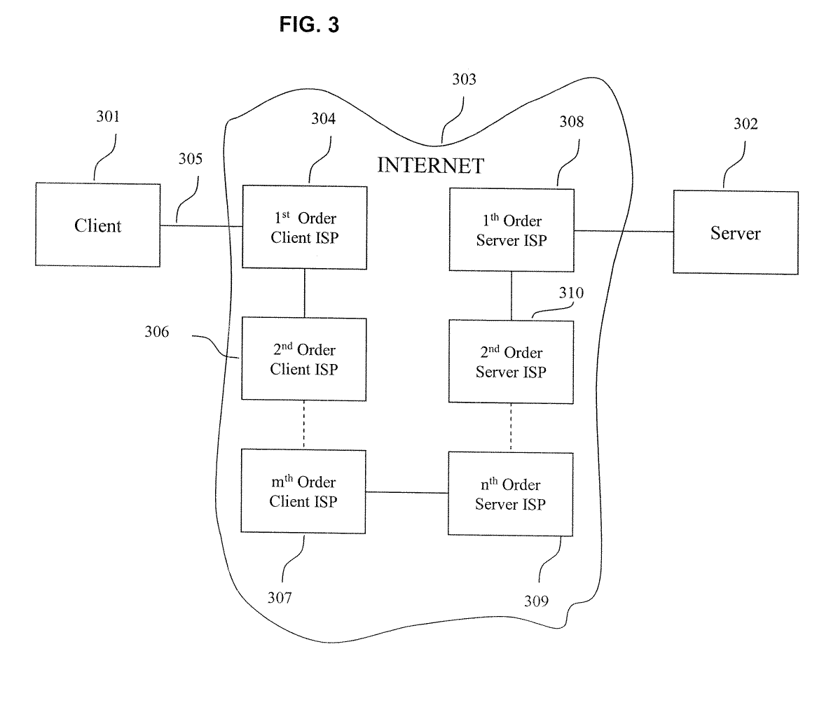

FIG. 3 illustrates how a client 301 and server 302 may be connected via the Internet 303. The client typically has an Internet Service Provider (ISP), such as first-order ISP 304. The client 301 connects to 304 via path 305 which may be any of several types of connection including dial-up, DSL, cable modem, fixed wireless, Wi-Fi, and cellular. First-order ISP 304 may have its own ISP, 306, which in turn may have its own ISP and so on. FIG. 3 depicts a hierarchy of m ISP's on the client side. A similar structure exists on the server side, where the server has an ISP 308, which itself is part of a chain of ISP's that goes up to an nth ISP 309, which connects with the mth ISP on the client side. (The mth client ISP and the nth server ISP may be the same ISP.) The point of FIG. 3 is that Internet traffic/data exchanged between a client 301 and a server 302 typically passes through the gateways (also known as edge routers) of several Internet Service Providers.

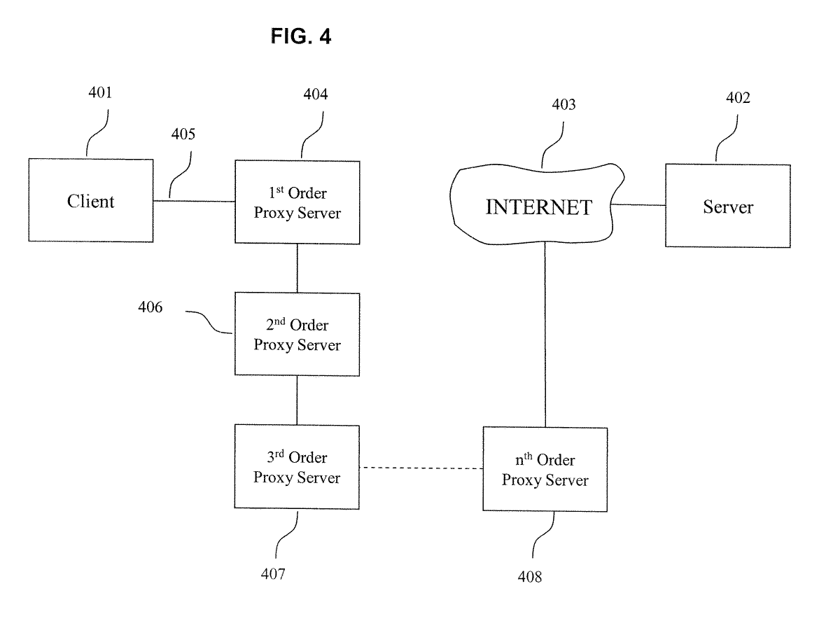

FIG. 4 shows that Internet traffic between a client 401 and a server 402 may pass through one or more proxy servers 404 before flowing through the Internet 403. A proxy server “hears” and services requests from its clients, often re-initiating requests on behalf of its clients and passing the corresponding responses to the clients. A client may explicitly redirect traffic to the proxy server, or the traffic may be redirected without the explicit specification of the client. The connection between the client and the proxy server 405 may take several forms, including a point-to-point connection, a connection over a local area network, or a connection over the Internet. Also, as with the hierarchy of ISP's, it is possible to have a hierarchy of proxy servers 406, 407 and 408 as shown in FIG. 4.

FIG. 3 and FIG. 4 illustrate that there may be several entities on the path between a client and a server. This can be true even if the client and the server are on the same local area network or wide area network (i.e., not connected over the Internet). For purposes of this application, any such entity on the path between a client and a server will be referred to as an “intermediate network entity” (INE). By virtue of being physically in the path between the client and the server, an INE potentially can modify the client's request message before it reaches the server, as well as the server's response message before it reaches the client. An INE may comprise a proxy server; an ISP; or a VPN device, for example.

HTTP Requests

There are primarily two types of an HTTP request, in terms of how an HTTP request is generated. The first is a Link Request, which is an HTTP request that is generated when for an example an end-user clicks on a hyper-link in a Web Page, or enters an address in the URI address box. The second type is an Embedded Object Request, which is generated by the web-browser automatically as it parses a Web Page and identifies embedded objects (e.g., images, JavaScript etc) for which separate HTTP requests need to be generated. An Embedded Object Request may be in several forms including but not limited to: a) the HTML attribute “src” followed by “=” and a URI, and b) a JavaScript-generated HTTP request.

The HTTP request itself consists of a header and a body. The header contains several fields, most notably the Cookie field and the URI field.

URI stands for Uniform Resource Identifier, and it has several other names such as WWW address, Universal Document Identifier, and Uniform Resource Locators (URL). For the HTTP protocol, URI's are simply formatted strings which identify (via name, location, or any other characteristic) a resource [R. Fielding et al., “Hypertext Transfer Protocol—HTTP/1.1.” W3C Network Working Group. June 1999. Available at http://www.w3.org/Protocols/rfc2616/rfc2616.html.]. In HTTP, URI's can be represented in absolute form or relative to some known base URI. Absolute URI's always begin with a scheme name followed by a colon e.g., http://www.CNN.com. A relative URI needs be used in conjunction with a base URI, and the combination would form an absolute URI.

Downloading Web Pages

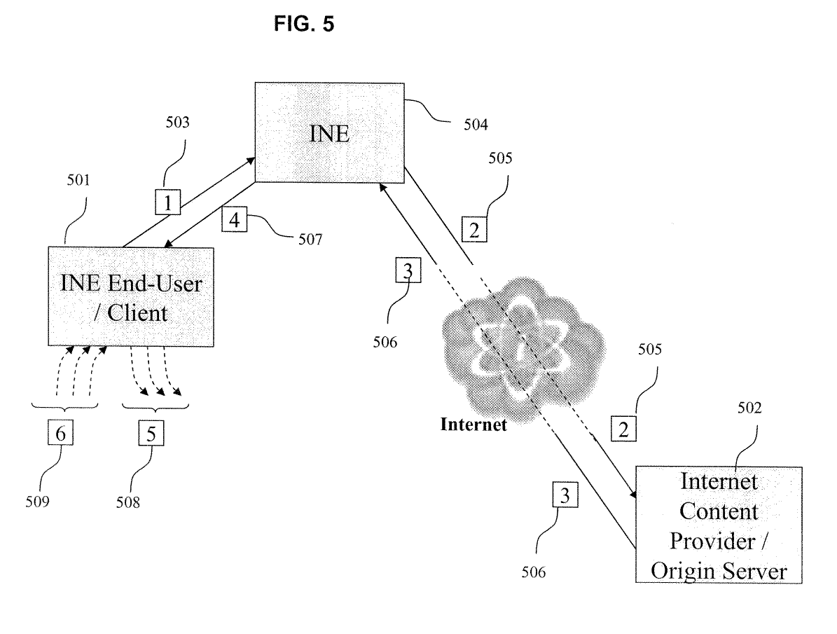

FIG. 5 provides a high-level view of the process that is undertaken when an INE end-user 501 downloads a Web Page from an origin server 502. The Web Page typically is not downloaded in one shot. 501's request for the Web Page 503 first travels to the ISP 504, which in turn forwards it through the Internet 505 to 502. 502 may return a main file for the Web Page (typically an HTML file) which contains embedded HTTP requests (i.e., Embedded Object Requests) for additional/other content (e.g., images, JavaScript code, HTML frames to be displayed within the Web Page). The Embedded Object Requests may or may not be destined to the same origin server 502. The initial response from 502 travels through the Internet to the ISP 506, and the ISP in turn forwards it 507 to the INE end-user 501. The INE end-user's web-browser parses the file received from the origin server. If the file contains any Embedded Object Requests then the web-browser will initiate a secondary set of HTTP requests 508 that correspond to the Embedded Object Requests. Each of the secondary HTTP requests goes through a similar process as the one described for the initial/primary request 503. The web-browser subsequently receives HTTP responses 509 to the secondary HTTP requests 508. Some of the secondary HTTP responses 509 may themselves contain Embedded Object Requests, which in turn may result in the initiation of a third round of HTTP requests. Therefore, the process of downloading a Web Page is recursive, and in theory one can design a Web Page that is infinitely recursive.

Banner-Ads

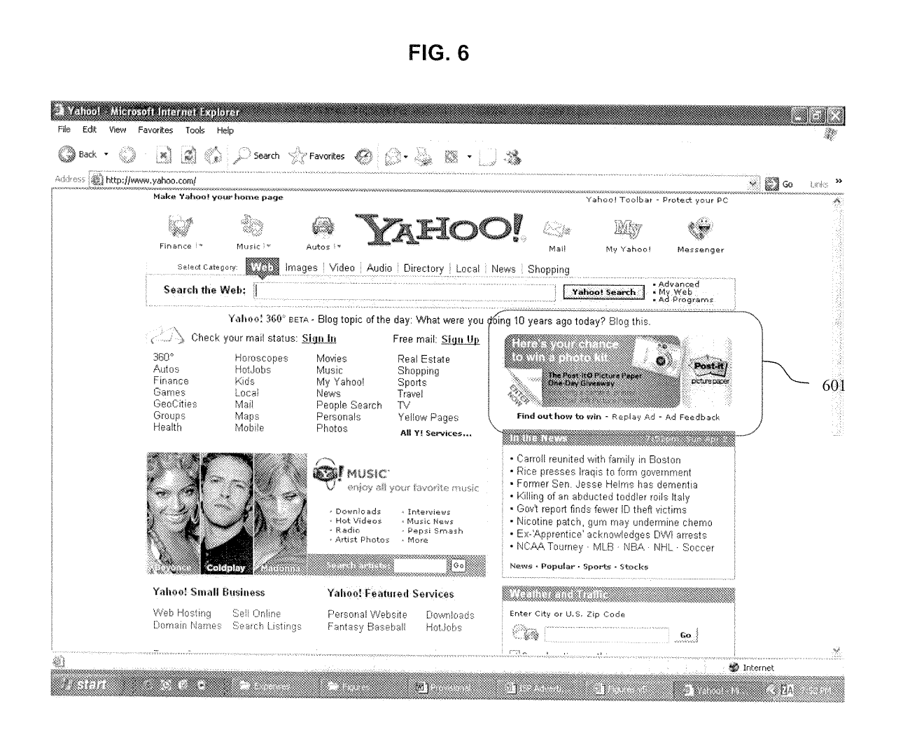

The Internet has increasingly become an important vehicle for advertising, competing with traditional forms such as radio, television, cinema, and print. Indeed, Internet advertising is the fastest growing sector in the advertising. One popular form of Internet advertising is banner-ads. FIG. 6 gives an example of a banner-ad 601.

The Web page provider (Content Provider) may have its own inventory of banner-ads. However, many Content Providers (e.g., YAHOO, AOL, and MSN) outsource the selling and creation of banner-ads to third-party ad servers (e.g., advertising.com, doubleclick.com). When partnering with a third-party ad server (TPAS), a Web Page designer typically:
1. Allocates space on the Web Page (visually) for banner-ads. The allocation process may include selecting the location and the dimensions of the banner-ad.
2. Inserts lines of code into the HTML content of the Web Page, whereby that those lines construct the banner-ad via the recursive Embedded Object Requests process described earlier. These lines of code will be referred to as “codelets”. A codelet may be written in several ways including but not limited to
   a. Plain HTML
   b. JavaScript.

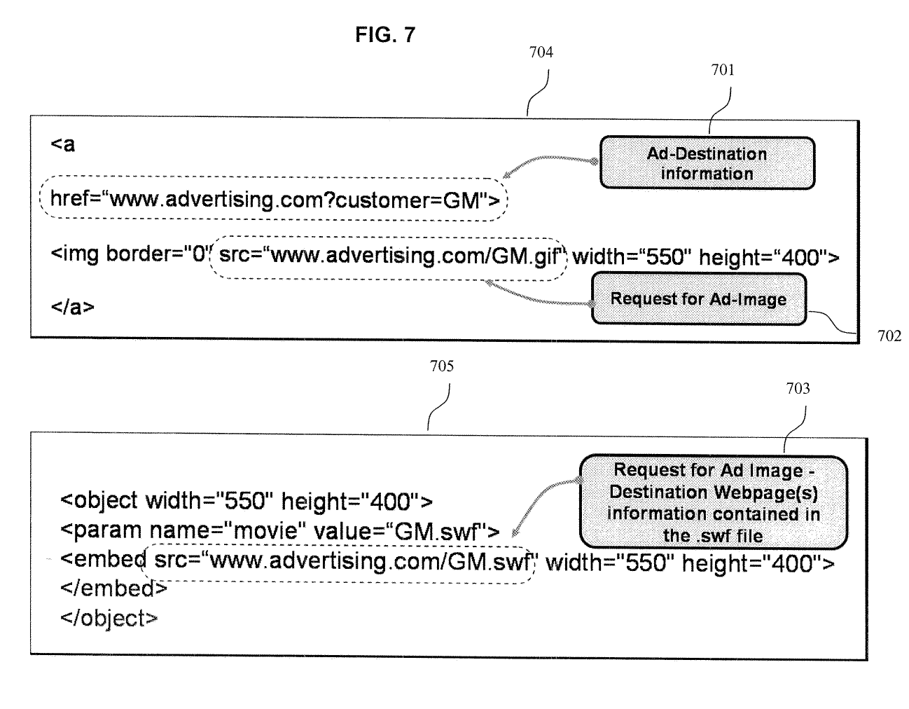

The codelet may be contiguous and contained in one part of the HTML file, or it may be disjointed and divided into several pieces that are spread out in small parts in the HTML file. The case of “disjointed codelets” is common when the codelet is written in JavaScript. In that case, one of the pieces of the disjointed codelet is the “trigger codelet” which initiates the banner-ad request and construction. The other pieces are “support codelets” which may for example be used to declare variables and/or assign them values. FIG. 7 shows examples of codelets 704 and 705.

A banner-ad is generally characterized by:
1. The ad-destination: In some rare cases, a banner-ad may be passive in that it is simply a display that cannot be clicked on. However, in most cases the banner-ad has one or several ad-destinations associated with it, whereby upon clicking on the banner-ad, or a particular section of the banner-ad, the end-user is taken to another Web Page (either in the same web-browser window or in a new web-browser window). The ad-destination refers to the Web Page to which the end-user is taken to upon clicking on the banner-ad.
2. The ad-image: This refers to what the end-user sees when he/she sees the banner-ad. The three most common files types for ad-images are: HTML (within an inline frame), GIF, and FLASH. One difference between GIF ad-images and the two types is that in the case of a GIF ad-image the ad-destination information is not contained in the GIF file itself. This implies that the ad-destination has to be specified outside the requested GIF file as illustrated by 701 and 702. In contrast, for a FLASH file, the ad-destination is included in the requested FLASH file as illustrated by 703.

It will be appreciated that the popular Google Adsense advertisements are one form of banner-ads.

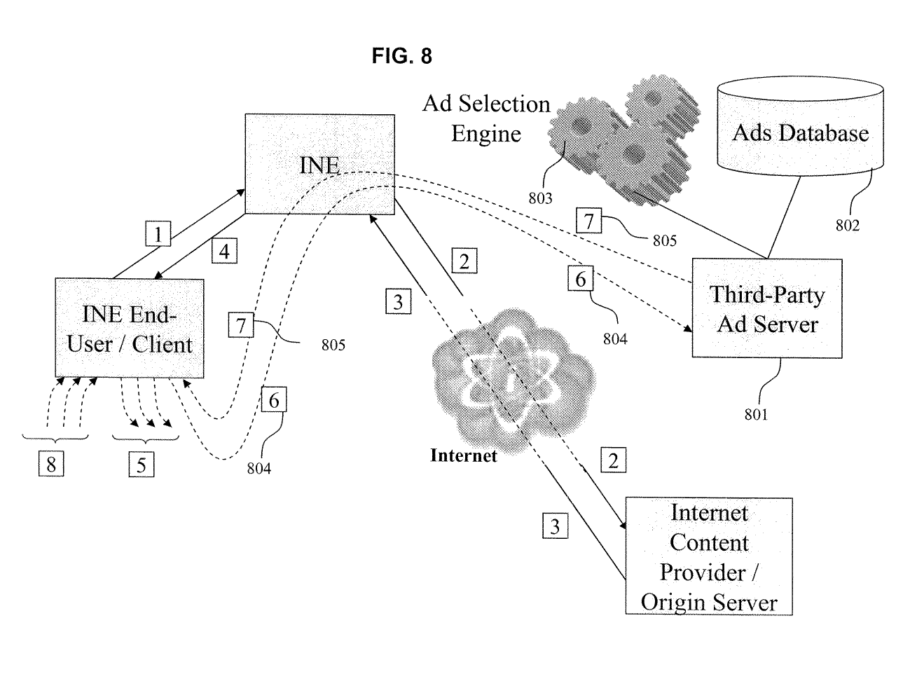

FIG. 8 illustrates, at high level, the process that takes place when a web-page contains banner-ads served by a TPAS. FIG. 8 is very similar to FIG. 5, with a difference that FIG. 8 contains the Third-Party Ad Server (TPAS) 801; a TPAS database 802 containing an inventory of banner-ads images, building-blocks, generators and other related information; and a smart engine 803 used to select which ads to be served to the INE end-user. One or more of the second or later-round HTTP requests may be made to the TPAS 804 and the TPAS serves the banner-ad 805.

Although the above discussion is focused on banner ads, a person skilled in the art would appreciate that a content provider may have designated areas in the Web Page intended to contain content other than banner advertisements; and that various aspects of the present invention can be used to form Mini-Webpages within a Web Page in such designated areas.

Here and elsewhere, modifications to an HTTP request may be performed using an HTTP request modification agent, such as a) ICAP's Request Modification procedure, and b) an agent developed using the Twisted network programming framework.

Here and elsewhere, modifications to an HTTP response may be performed using an HTTP response modification agent, such as a) ICAP's Response Modification procedure, and b) an agent developed using the Twisted network programming framework.

Twisted is an event-driven network programming framework written in Python and licensed under the MIT License [Twisted Matrix Labs HomePage. Available at http://www.twistedmatrix.com].

ICAP

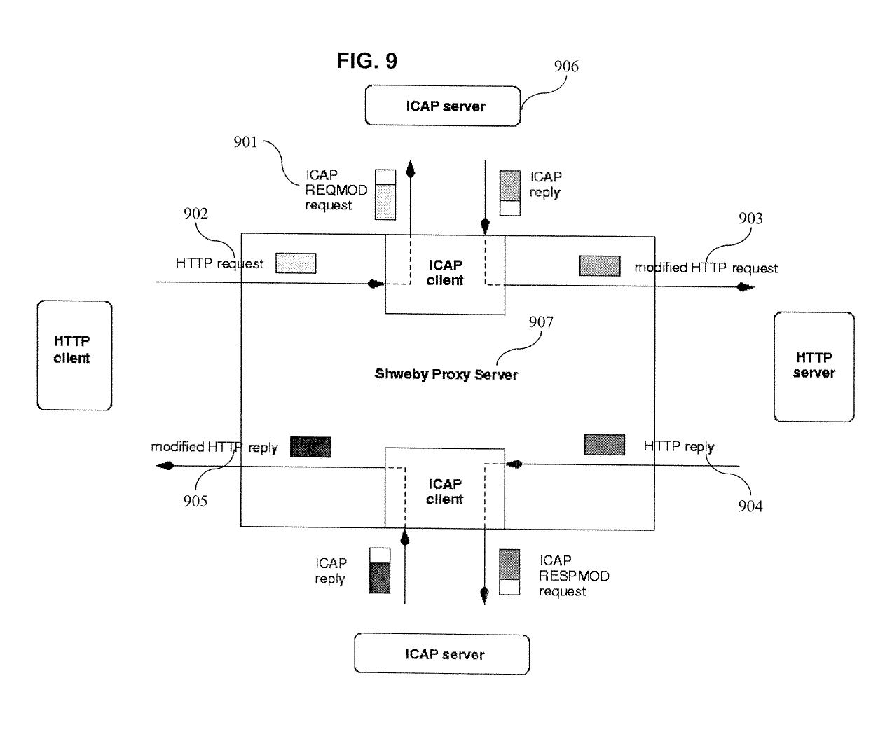

HTTP Request modifications and HTTP Response modifications may be implemented using the Internet Content Adaptation Protocol (ICAP). ICAP is an existing open standards protocol for content adaptation [J. Elson and A. Cerpa, “Internet Content Adaptation Protocol (ICAP).” W3C Network Working Group. April 2003. Available at http://www.ietf.org/rfc/rfc3507.txt]. It is intended to allow web proxy servers to alter HTTP requests and HTTP (server) responses at the point where these messages move through the proxy server. Accordingly, ICAP is typically used at the network edge. ICAP applications include virus scanning and protection, fixed-banner advertisement insertion, child-protection filtering, wireless device support on plain websites, and language translation services. There are at least two widely available proxy servers that are ICAP-capable: the squid proxy server and the Shweby proxy server. FIG. 9 shows the enhancement of the architecture of the Shweby proxy server to support ICAP. There are at least two main modes of ICAP operation. The first is REQMOD (REQuest MODification) 901, whereby before the HTTP request 902 is sent out to the intended (origin) web server, it is modified by the ICAP server 906, and a modified HTTP request 903 is instead sent out to Internet. If the proxy server 907 supports caching, then 902 may be modified pre-caching (i.e., while on its way into cache), or post-caching (i.e., on its way out of the cache). A second version of RESPMOD is virtual request modification, which entails having the proxy server supporting ICAP 907 supply an HTTP response for the HTTP request, without forwarding the HTTP request to another web server. A second main mode of ICAP operation is RESPMOD (RESPonse MODification), whereby an HTTP response 904 from the web server is modified by the ICAP server before the modified HTTP response 905 is sent back the user's web browser. Similar to HTTP request modification, HTTP response modification may occur before the HTTP response is cached, or on the responses way out of the cache heading back to the user's web browser.

Various aspects of the present invention which facilitate an Intermediate Network Entity (INE) to modify or cause the modification of a Web Page requested an end-user are described below. The modification of the requested Web Page involves placing of one or more mini-Webpages in designated areas of the requested Web Page using a variety of methods. Some of these methods are described in detail below. However, it will be appreciated that the various aspects of the present invention can be implemented in several other ways without deviating from the spirit of the present invention and all such methods are intended to be with in the scope of the present invention.

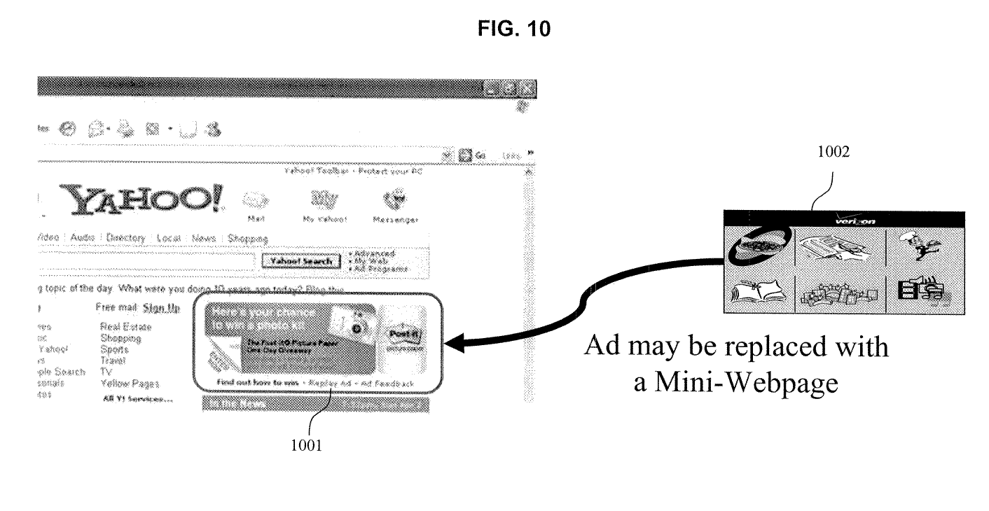

One or more aspects of the present invention can advantageously enable an INE to substitute the designated area with a Mini-Webpage. FIG. 10 illustrates an example of the present invention, where the Web Page originally contains a banner-ad 1001 that will be substituted with a Mini-Webpage 1002. The Mini-Webpage may emulate the full-functionality of a full web-page or it may be different from the full Web Page. For example, Mini-Webpage can be different from the full Web Page in that it may likely be contained within a larger Web Page and that its dimensions may not necessarily span the dimensions of the web-browser's main window.

The Mini-Webpage can contain any content. For example, the Mini-Webpage can contain general web-content. The Mini-Webpage can be implemented using different formats including but not limited to: a) Mini-Webpage being an HTML table, whereby the cells may contain GIF images, b) Mini-Webpage being a FLASH file, and c) Mini-Webpage being an Inline Frame (iframe). The ISP or INE may have information about the Internet end-user receiving the Web Page, including but not limited to:
1. Location of the end-user (which may be obtained using a variety of methods)
2. Demographic data about the end-user
3. Preferred language
4. Data on the periods of usage by the end-user
5. Data on web-browsing/Internet surfing behavior by the end-user
6. Data on e-commerce activities conducted by the end-user
7. In cases where a computer or an Internet address is shared by multiple INE end-users, the types of INE end-users including but not limited to information about the end-users' identities and periods of usage.

The information about the end-user, that the INE has, may be used to customize the content of the Mini-Webpage according to several parameters including but not limited to the end-user, his/her location, his/her demographic profile, his/her Internet usage pattern, and his/her overall context.

According to one aspect of the invention, a method for rendering one or more Mini-Webpages within a requested Web Page by an INE is described. This aspect of the invention involves: a) receiving, by an INE from an end-user, a request for a Web Page located at a specified web address; b) processing of the request for the Web Page by the INE; modifying the requested Web Page such that the requested Web Page when delivered to the web browser contains at least one Mini-Webpage in one or more designated areas of the requested Web Page; and d) delivering the modified Web Page along with the at least one Mini-Webpage to the web browser. The designated areas of the Web Page can be any predetermined areas including but not limited to areas in which advertisements such as banner ads are intended.

According to one embodiment of this aspect of the present invention, an INE can modify a Web Page requested by an end-user by placing one or more Mini-Webpages into the requested Web Page. This embodiment of the invention involves conveying the end-user information to the TPAS for the TPAS itself to return a Mini-Webpage (customized according to the end-user information) in a designated area of the requested Web Page. For example, the Mini-Webpage can be placed in an area intended for an advertisement such as a banner-ad. The Mini-Webpage may additionally be customized according to other parameters including but not limited to: a) the INE (if the INE identifies itself to the TPAS using for example a unique identifier (UID), and b) the content/context of the Web Page requested by the INE end-user and provided by the Content Provider. The INE may determine the content/context of the Web Page by examining/processing/parsing the HTTP response(s) (similar to 507 and/or 509 of FIG. 5) from the Content Provider. Based on the collective information received by the TPAS, the TPAS may return the Mini-Webpage in the designated area.

The end-user information can be conveyed to the TPAS, for example, by embedding the information in an HTTP request. Several methods can be used for embedding end-user Information in the HTTP request and some of these include but are not limited to:
a) Including Information in the URI (within the HTTP request) as URI Query Parameters (with appropriate corresponding values and using the standard “&” and “?” convention). The names of the URI Query Parameters may be pre-defined and agreed upon by any combination of the INE, Web page provider (Content Provider) and TPAS among others.
b) Including Information in the URI (within the HTTP request) as virtual URI Query Parameters (with appropriate corresponding values) using an agreed upon convention including but not limited to specially-named directories in the modified URI. The names of the virtual URI Query Parameters may be pre-defined and agreed upon by any combination of the INE, Web page provider (Content Provider) and TPAS among others.
c) Modifying the values of existing URI Query Parameters and/or existing virtual URI Query Parameters in the HTTP request containing the requested URI.
d) Inserting one or more cookie(s) in the Cookie field in the header of the HTTP request containing the requested URI. The inserted cookie(s) contain(s) the Information. The name(s) of the cookie(s) may be pre-defined and agreed upon by any combination of the INE, Web page provider (Content Provider) and TPAS among others.
e) Modifying the values of existing cookies in the Cookie field in the header of the HTTP request.
f) Creating a special field or multiple special fields in the header of the HTTP request (similar to shown in FIG. 5, 503 and/or 508) and inserting in that/those field(s) the Information. The name(s) of the special field(s) may be pre-defined and agreed upon by any combination of the INE, Web page provider (Content Provider) and TPAS among others.
g) Including Information in the HTTP request as POST Parameters, and if necessary, changing the HTTP request to a POST request. The names of the POST Parameters may be pre-defined and agreed upon by any combination of the INE, Web page provider (Content Provider) and TPAS among others.
h) Modifying the values of existing POST Parameters in the HTTP request.

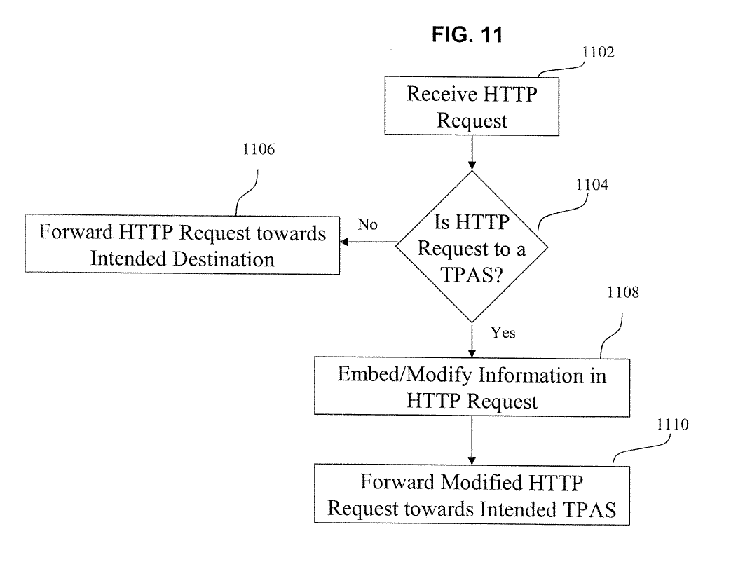

FIG. 11 provides a high-level illustration of this method for conveying information to the TPAS. Upon receiving an HTTP request 1102, the INE determines whether the HTTP request is intended for a TPAS 1104. If it is not, then it simply forwards the request to the intended destination 1106. If it is, then the INE embeds the information in the HTTP request 1108; and forwards the modified HTTP request to the intended TPAS 1110.

The information that can be conveyed may include: a) Information about the end-user, b) Information about the INE, and c) Information about the content/context of the Web Page requested by the INE end-user and provided by the Content Provider. The INE may determine the content/context of the Web Page by examining/processing/parsing the HTTP response(s) (similar to FIG. 5, 507 and/or 509) from the Content Provider.

The end-user information may also be conveyed to the TPAS by modifying the HTTP response containing the requested Web Page. One example of this involves using ICAP's RESPMOD (Response Modification) procedure to augment/modify codelets (without necessarily entirely replacing them) within the HTTP response from the Web Page provider (Content Provider) 506 such that information ultimately received by the TPAS, in HTTP requests, is sufficient to serve an appropriate Mini-Webpage. One illustrative example is a codelet that is a JavaScript procedure, whereby certain parameters within it (e.g., City, Region, Country) were not specified by the Web Page provider (Content Provider), and are hence set to NULL. The INE may use the Response Modification agent to populate those parameters with relevant values.

The end-user information may also be conveyed to the TPAS offline by using transmission methods including but not limited to FTP and email.

In some exemplary embodiments of the invention, based on the received information, the TPAS may return the Mini-Webpage in place of the banner-ad. The Mini-Webpage may be customized according to several parameters including but not limited to:
1. The end-user.
2. The INE (if the INE identifies itself to the TPAS using for example a unique identifier (UID)).
3. The content/context of the Web Page requested by the INE end-user and provided by the Content Provider.

According to another embodiment of the present invention, an INE can modify a Web Page requested by an end-user by placing one or more Mini-Webpages into the requested Web Page. This embodiment of the invention involves conveying the end-user information to a Web Page provider (Content Provider) for the latter to form the Mini-Webpage within the Web Page. The end-user information may be conveyed directly to the Web Page provider (Content Provider) offline using transmission methods including email and FTP. The end-user information may also be conveyed to the Web Page (Content Provider) within one or more of the recursive HTTP requests to the Web Page Provider (Content Provider).

Several methods of embedding information of an end-user in an HTTP request to the Web Page provider (Content Provider) (similar to 503 and/or 508 of FIG. 5) are described below. Some of those methods include a) including Information in the URI (within the HTTP request) as URI Query Parameters (with appropriate corresponding values and using the standard “&” and “?” convention), whereby the names of the URI Query Parameters may be pre-defined and agreed upon by any combination of the INE, Web page provider (Content Provider) and TPAS among others; b) including Information in the URI (within the HTTP request) as virtual URI Query Parameters (with appropriate corresponding values) using an agreed upon convention including but not limited to specially-named directories in the modified URI, whereby the names of the virtual URI Query Parameters may be pre-defined and agreed upon by any combination of the INE, Web page provider (Content Provider) and TPAS among others; c) modifying the values of existing URI Query Parameters and/or existing virtual URI Query Parameters in the HTTP request containing the requested URI; d) inserting one or more cookie(s) in the Cookie field in the header of the HTTP request, whereby the inserted cookie(s) contain(s) the Information, and the name(s) of the cookie(s) may be pre-defined and agreed upon by any combination of the INE, Web page provider (Content Provider) and TPAS among others; e) modifying the values of existing cookies in the Cookie field in the header of the HTTP request; f) creating a special field or multiple special fields in the header of the HTTP request 503 and/or 508 and inserting in that/those field(s) the Information, whereby the name(s) of the special field(s) may be pre-defined and agreed upon by any combination of the INE, Web page provider (Content Provider) and TPAS among others; g) including Information in the HTTP request as POST Parameters, and if necessary, changing the HTTP request to a POST request, whereby the names of the POST Parameters may be pre-defined and agreed upon by any combination of the INE, Web page provider (Content Provider) and TPAS among others; and h) modifying the values of existing POST Parameters in the HTTP request.

The end-user information may also be conveyed to the Web Page provider (Content Provider) by using a Response Modification agent such as ICAP's RESPMOD procedure to modify the requested Web Page. One example of this involves using ICAP's RESPMOD (Response Modification) procedure to augment/modify certain segments of the Web Page (without necessarily entirely replacing them) within the HTTP response from the Web Page provider (Content Provider) 506 such that information ultimately received by the Web Page provider (Content Provider), including information received by Web Page provider via all recursive HTTP requests, is sufficient to serve an appropriate Mini-Webpage.

For purposes of one or more embodiments of the present invention, the conveyed information can be selected based on appropriate criteria and can include information, such as: a) information about the end-user, and b) information about the INE. In some examples, based on the received information, the Web Page provider (Content Provider) may construct the Mini-Webpage in place of the banner-ad. The Mini-Webpage may be customized based on several parameters and some non-limiting examples of those parameters include: 1) The end-user, 2) The INE (if the INE identifies itself to the Web Page provider (Content Provider) using for example a unique identifier (UID)), and 3) The content/context of the Web Page requested by the INE end-user and provided by the Web Page provider (Content Provider).

In yet another embodiment of the present invention, methods are described which facilitate an INE or an INE related entity to implement modification of a Web Page requested by an end-user. Examples of this embodiment involve redirecting the HTTP request originally intended for the TPAS (similar to 804 of FIG. 8) to another web-server that may be operated by the INE itself or by another party. In one example of this embodiment, the redirection may involve using an IP redirection agent, which instead of forwarding a packet towards its intended IP destination, forwards the packet towards another web-server. Upon receiving the request, the web-server may extract information from the HTTP Request. The extractable information may include but not limited to: a) the dimensions of the banner-ad, and b) the file-type of the banner ad. Based on the extracted information as well as other information that may be provided by the INE, the web-server can serve an appropriately customized Mini-Webpage. The Mini-Webpage may be customized based on several parameters and some non-limiting examples of those parameters include: 1) The end-user, 2) The INE (if the INE identifies itself to the Web Page provider (Content Provider) using for example a unique identifier (UID)), and 3) The content/context of the Web Page requested by the INE end-user and provided by the Web Page provider (Content Provider).

Another example of this embodiment of the present invention utilizes request modification. For example, ICAP's REQMOD (Request Modification) procedure may be used to replace the URI in the HTTP request with another URI corresponding to another server. The new URI may contain information extracted from the original HTTP Request including but not limited to: a) the dimensions of the banner-ad, and b) the file-type of the banner ad. Based on the extracted information as well as other information that may be provided by the INE, the web-server will serve an appropriately customized Mini-Webpage. The Mini-Webpage may be customized based on several parameters and some non-limiting examples of those parameters include: 1) The end-user, 2) The INE (if the INE identifies itself to the Web Page provider (Content Provider) using for example a unique identifier (UID)), and 3) The content/context of the Web Page requested by the INE end-user and provided by the Web Page provider (Content Provider).

In another example of this embodiment of the present invention, ICAP's REQMOD (Request Modification) procedure may be used to perform a virtual redirection and immediately return an HTTP response that is an appropriately customized Mini-Webpage based on the information in the original HTTP Request as well as information that may be provided by the INE. The Mini-Webpage may be customized based on several parameters and some non-limiting examples of those parameters include: 1) The end-user, 2) The INE (if the INE identifies itself to the Web Page provider (Content Provider) using for example a unique identifier (UID)), and 3) The content/context of the Web Page requested by the INE end-user and provided by the Web Page provider (Content Provider).

In yet another embodiment of the present invention, ICAP's RESPMOD (Response Modification) procedure may be used to process the HTTP response containing the formation of the designated area (such as a banner ad) from the Web Page provider (Content Provider) (similar to 507 and/or 509 of FIG. 5); or from the TPAS 805 of FIG. 8. The processing performed by ICAP's RESPMOD procedure may include replacing the HTTP response with an appropriately customized Mini-Webpage. The Mini-Webpage may be customized based on several parameters and some non-limiting examples of those parameters include: 1) The end-user, 2) The INE (if the INE identifies itself to the Web Page provider (Content Provider) using for example a unique identifier (UID)), and 3) The content/context of the Web Page requested by the INE end-user and provided by the Web Page provider (Content Provider).

In one example of an embodiment of the present invention, ICAP's RESPMOD (Response Modification) procedure can be used to replace the trigger codelet for the banner ad in the HTTP response from the Web Page provider (Content Provider) (similar to 507 and/or 509 of FIG. 5) with another codelet that results in the formation of an appropriately customized Mini-Webpage. The Mini-Webpage may be customized based on several parameters and some non-limiting examples of those parameters include: 1) The end-user, 2) The INE (if the INE identifies itself to the Web Page provider (Content Provider) using for example a unique identifier (UID)), and 3) The content/context of the Web Page requested by the INE end-user and provided by the Web Page provider (Content Provider). The new codelet may contain information that is extracted from the original codelet including but not limited to:
a. The dimensions of the banner-ad.
b. The file-type of the banner ad.

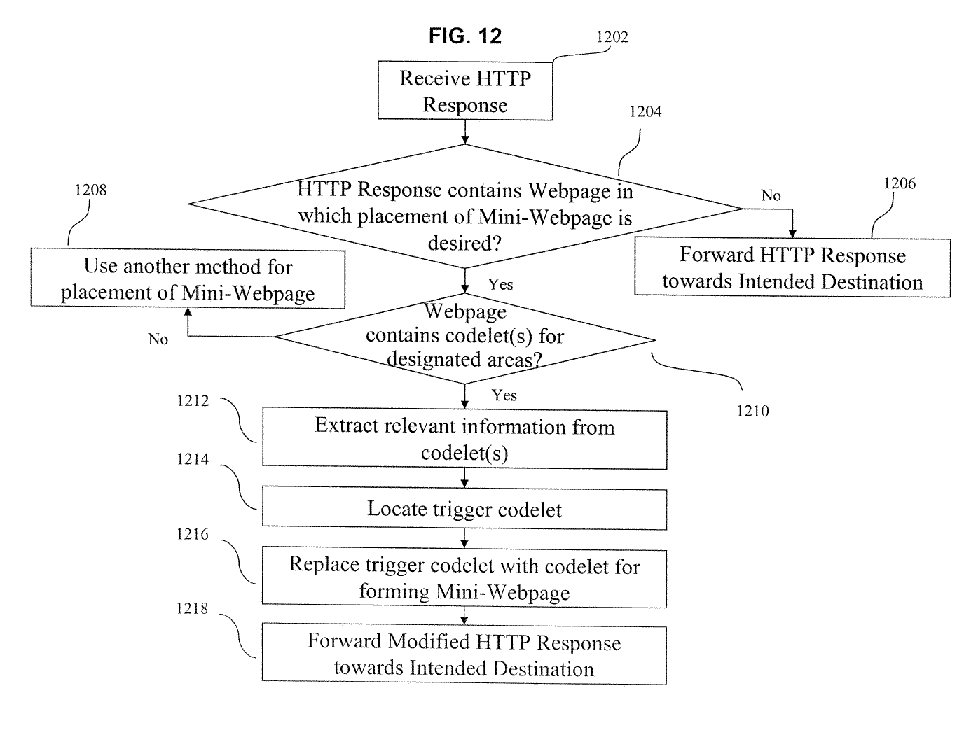

FIG. 12 provides a high-level illustration of an example of this method. Upon receiving an HTTP response 1202, the INE determines whether the HTTP response contains a Web Page in which the placement of a Mini-Webpage is desired 1204. If it is not desired, then the response is simply forwarded to its intended destination 1206. If on the other hand it is desired, then the INE locates codelets for designated areas of interest 1210. If none are found, then the INE may use an alternative method for placing the Mini-Webpage 1208. If such codelets are found, then the INE may extract the codelet(s) 1212, may locate the trigger codelet 1214, may replace the trigger codelet with another for forming the desired Mini-Webpage 1216, and may forward the modified response to its intended destination 1218.

In another aspect of the present invention, systems for enabling an Intermediate Network Entity (INE) to modify a Web Page requested by an end-user by placing one or more Mini-Webpages within the requested Web Page are disclosed. These systems included means for an end-user to request a Web Page; means for receiving and processing the request by an INE from a web browser of an end-user; means for modifying the requested Web Page by placing one or more Mini-Webpages in the requested Web Page by the INE; means for delivering the modified Web Page containing the one or more Mini-Webpages to the web browser of the end-user.

A system or method for requesting a Web Page by an end-user using the objects of the present invention may include using a web-browser application, such as Internet Explorer, on an end device such as a desktop computers, laptop computers, workstations, smartphones and PDA's, to make a request for a Web Page. Such end devices may transmit and receive data using one or more technologies including but not limited to dialup connection, DSL, high-speed Internet by a Cable company, WiFi, WiMax, and cellular connection. Means for serving Web Pages by Web Page providers (Content Providers) and advertisements by TPAS's include using a web server application, such as Apache, supported by a database application, such as mysql, hosted on one or more general purpose computers. Means for serving Mini-Webpages by TPAS's, INE's or Web Providers include using a web server application, such as Apache, supported by a database application, such as mysql, hosted on one or more general purpose computers. Means for receiving and processing a request by INE's may include using an IP redirection agent, such as iptables, and a software implementation of ICAP (with proxy server support), all which may be hosted on one or more network appliances (e.g., edge routers, proxy servers) and/or general purpose computers. Means for modifying the requested Web Page by the INE and delivering the modified Web Page containing the one or more Mini-Webpages to the web browser of the end-user may include using a software implementation of ICAP (with proxy server support), which may be hosted on one or more network appliances (e.g., edge routers, proxy servers) and/or general purpose computers.

In another aspect of the invention systems for enabling an Intermediate Network Entity (INE) to modify a Web Page requested by an end-user by placing one or more Mini-Webpages within the requested Web Page are disclosed. These systems include an input device that would enable an end-user to request a Web Page via a web browser; a device that can transmit the request; a Web Page processing agent of an INE that can receive and process the request; a Web Page modification agent used to alter the requested Web Page and create a Mini-Webpage; and a Web Page delivering agent; wherein the Web Page delivering agent returns to the web browser of the end-user the Mini-Webpage.

A system for enabling the described invention may comprise an end device for the end-user, including but not limited to a desktop computer, a laptop computer, a workstation, a smartphone and a PDA. The end device may be equipped with a web browsing software application, such as Internet Explorer or Firefox, and may transmit and receive data using one or more technologies including but not limited to dialup connection, DSL, high-speed Internet by a Cable company, WiFi, WiMax, and cellular connection. The system may also comprise of one or more web servers, whereby such web servers may be general purpose computers equipped with software applications such as a web server application and a database application. Web servers may be used by TPAS's, Web Page providers (Content Providers), INE's and INE related parties to supply various types of web content. The web servers may transmit and receive data. The system may also have one or more conventional network appliances such as edge routers and proxy servers that additionally contain special-purpose software, and/or one or more general purpose computers containing special-purpose software; whereby the collective special-purpose software (over the network appliances and the general-purpose computers) may allow the INE to perform request modification, response modification, and other steps necessary for introducing Mini-Webpages, and delivering modified Web Pages to end-users.

In yet another aspect of the invention, machine readable media that contains instructions are described. If executed by a machine, the media containing the instructions according to this embodiment of the invention can cause the machine to execute a set of operations to enable an Intermediate Network Entity (INE) to modify a Web Page requested by an end-user by placing one or more Mini-Webpages within the requested Web Page. The machine readable medium of this aspect of the invention contain instructions that when executed enable operations resulting in receiving by an Intermediate Network Entity (INE) from an end-user a request for a Web Page located at a specified web address; processing of the request for the Web Page by the INE; modifying the requested Web Page such that the requested Web Page when delivered to the web browser contains at least one Mini-Webpage in place of one or more advertisements; and delivering the modified Web Page along with the at least one Mini-Webpage to the web browser.

The described invention may be generalized to a case of a Web Page containing multiple designated areas with all, some or none of the designated areas being replaced by appropriately customized Mini-Webpages. The described invention may also be generalized to a situation with multiple INE Customers communicating with multiple Content Providers.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for rendering at least one Mini-Webpage within a requested Web Page by an Intermediate Network Entity (INE), comprising the steps of:
receiving a request for a Web Page located at a specified web address from an end-user by an INE;
processing of the request for the Web Page by the INE;
modifying the requested Web Page such that the requested Web Page has at least one Mini-Webpage into at least one designated area when delivered to the web browser; and
delivering the modified Web Page along with the at least one Mini-Webpage to the web browser.

2. The method of claim 1, wherein the at least one designated area corresponds to at least one advertisements.

3. The method of claim 1, wherein modifying the requested Web Page further comprises the steps of:
delivering information of the end-user to a third party ad server (TPAS) from the INE; and
providing the Mini-Webpage by the TPAS.

4. The method of claim 3, wherein the at least one Mini-Webpage provided by the TPAS is selected based on at least one of information from the INE and nature of the requested Web Page.

5. The method of claim 3, wherein the information of the end-user is delivered to the TPAS before, during, or after receiving the request for the Web Page.

6. The method of claim 3, wherein the step of delivering the modified Web Page further comprises the step of placing the information of the end-user in a Hypertext Transfer Protocol (HTTP) request to the TPAS.

7. The method of claim 6, wherein the step of placing the information of the end-user within the HTTP request comprises the step of placing the information of the end-user in a Uniform Resource Identifier (URI) as URI query parameters.

8. The method of claim 6, wherein the step of placing the information of the end-user within the HTTP request comprises the step of placing the information of the end-user in a URI as virtual URI query parameters.

9. The method of claim 6, wherein the step of placing information of the end-user comprises the step of inserting at least one cookie in a cookie field in a header of the HTTP request.

10. The method of claim 6, further comprising the step of placing the information of the end-user in one or more special fields formed in a header of the HTTP request.

11. The method of claim 6, further comprising the step of placing the information of the end-user in the HTTP request as one or more POST parameters.

12. The method of claim 6, further comprising the step of conveying the information of the end-user to the TPAS by appropriately modifying codelets in an HTTP response, wherein the HTTP request has the information.

13. The method of claim 1, wherein the step of delivering the modified Web Page further comprises the step of redirecting a Hypertext Transfer Protocol (HTTP) request intended for a Third Party Ad Server (TPAS) to at least one web server.

14. The method of claim 13, wherein the step of redirecting of the HTTP request comprises at least one of using an Internet Protocol (IP) redirection agent and using an agent to replace a URI in the HTTP request with another URI corresponding to another server.

15. The method of claim 14, wherein the redirected HTTP request contains the information of the end-user.

16. The method of claim 15, wherein the information of the end-user is placed in the HTTP request by at least one of placing the information of the end-user in a URI as URI query parameters, placing the information of the end-user in the URI as virtual URI query parameters, in a cookie field in a header of the HTTP request, in a special field in the header of the HTTP request, in the body of the HTTP request as POST parameters, and appropriately modifying codelets in an HTTP response, wherein the HTTP request contains the information.

17. The method of claim 13, wherein the step of redirecting of the HTTP request comprises using an agent to perform a virtual redirection by immediately returning an HTTP response.

18. The method of claim 14, in which the one or more Mini-Webpages are further formed by the step of extracting information from the URI.

19. The method of claim 1, wherein the step of modifying the requested Web Page further comprises the step of delivering the information of the end-user to a Web Page provider from the INE and modifying the requested Web Page by the Web Page provider.

20. The method of claim 19, wherein the information of the end-user is delivered to the Web Page provider by placing the information of the end-user in an HTTP request.

21. The method of claim 19, wherein the Mini-Webpage is formed by the Web Page provider according to at least one of information provided by the INE, and the nature of the requested Web Page by the end-user.

22. The method of claim 20, wherein the information of the end-user is placed in the HTTP request by at least one of placing the information in a URI as URI query parameters, placing the information in the URI as virtual URI query parameters, in a cookie field in a header of the HTTP request, in a special field in the header of the HTTP request, in the body of the HTTP request as POST parameters, and appropriately modifying codelets in an HTTP response such that the HTTP request contains the information.

23. The method of claim 1, wherein the step of delivering of the modified content further comprises the step of using a response modification agent that modifies the response to place a Mini-Webpage.

24. The method of claim 23, wherein the response modification comprises at least one of replacing a trigger codelet for the advertisement in a HTTP response from the Web Page provider with another codelet that results in a formed Mini-Webpage and modifying one or more codelets for the designated areas within the HTTP response.

25. A system for enabling an Intermediate Network Entity (INE) to modify a Web Page requested by an end-user by placing one or more Mini-Webpages within the requested Web Page, comprising:
means for an end-user to request a Web Page;
means for receiving and processing the request by an INE from a web browser of an end-user;
means for modifying the requested Web Page by the INE by placing one or more Mini-Webpages in the requested Web Page;
means for delivering the modified Web Page containing the one or more Mini-Webpages to the web browser of the end-user.

26. A system for enabling an Intermediate Network Entity (INE) to modify a Web Page requested by an end-user by placing one or more Mini-Webpages within the requested Web Page, comprising:
an input device that would enable an end-user to request a Web Page via a web browser;
a device that can transmit the request;
a Web Page processing agent of an INE that can receive and process the requested Web Page;
a Web Page modification agent used to alter the requested Web Page and create a Mini-Webpage; and
a Web Page delivering agent;
wherein the Web Page delivering agent returns to the web browser of the end-user the Mini-Webpage.

27. A machine readable medium storing instructions that, if executed by the machine, cause the machine to execute a set of operations enabling an Intermediate Network Entity (INE) to modify a Web Page requested by an end-user by placing one or more Mini-Webpages within the requested Web Page comprising:
receiving by an Intermediate Network Entity (INE) from an end-user a request for a Web Page located at a specified web address;
processing of the request for the Web Page by the INE;
modifying the requested Web Page such that the requested Web Page when delivered to the web browser contains at least one Mini-Webpage in place of at least one advertisement; and
delivering the modified Web Page along with the at least one Mini-Webpage to the web browser.

28. The method of claim 17, in which the one or more Mini-Webpages are further formed by the step of extracting information from the URI.
